(19) United States
(12) Patent Application Publication
(10) Pub. No.: US 2005/0092365 A1
(43) Pub. Date: May 5, 2005

(54) Extrusion assembly

(76) Inventors: Godfrey D. Rawes, (US); Leslie P. Snowden, Deeside (GB); Mark A. Brick, Pickerington, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/974,234

(22) Filed: Oct. 27, 2004

Related U.S. Application Data
(60) Provisional application No. 60/515,192, filed on Oct. 28, 2003.

(51) Int. Cl. B26D 3/00; F16K 15/20

(52) U.S. Cl. 137/233

(57) ABSTRACT

A pumping and slicing apparatus and method with a pump that pumps fluent food product material through a flow divider and into multiple tubes that restrict the flow of material to remove voids. The food product is extruded through an orifice and sliced, such as in a pendulum-slicing machine. The flow restrictions are formed by the orifices being flow-restrictive, by tapering the tubing from the pump to the orifice, or by interposing bodies, such as a plurality of pins, in the tubing to displace the food product. The flow restrictions remove unwanted voids in the food product, resulting in consistent food slices.

### BACKGROUND OF THE INVENTION

1. Field Of The Invention

This invention relates generally to food processing machines, and more particularly to a machine that extrudes fluent food products through an orifice for slicing.

2. Description Of The Related Art

Conventional food slicing machines, such as those shown in U.S. Pat Nos. 3,760,715 to Grote et al. and 4,436,012 to Hochanadel, which are incorporated herein by reference, use a continuous loop blade, configured in the manner of a band saw, to slice food products, such as meats, cheeses and vegetables. The blade is a razor-sharp metal band that extends in a loop around a drive wheel, an idling guide wheel and through a blade guide positioned between the wheels. The blade guide maintains the position of the blade relative to the food product to permit very accurate slicing.

The food product sliced by such machines is held in a carriage, such as a tube with an open bottom, that is reciprocated through a path that includes the blade to form slices of food during each cycle. The food product slides downwardly in the carriage during the tube's travel in one direction, and the slices formed fall downwardly onto a conveyor or other surface.

Food products conventionally sliced using the slicing machines described above are solid products, such as logs of meats and cheeses. There is a desire for other fluent food products, such as uncooked sausage, cookie dough and other fluent materials, to be sliced after extruding through an orifice of a particular shape.

### BRIEF SUMMARY OF THE INVENTION

The invention is a food-processing machine for pumping and slicing fluent food product, such as raw sausage or cookie dough. The machine comprises a pump for pumping the food product and a tube mounted to the pump. The tube has an internal passage in fluid communication with the pump for conveying the pumped fluent material through the passage. An orifice is formed near an end of the tube, and the orifice is in fluid communication with the passage. Thus, the pumped fluent material is extruded through the orifice, and a blade near the orifice slices the food product that is extruded out of the orifice.

Means for restricting the flow of the food product between the pump and the orifice remove unwanted voids in the food product. One restricting means is bodies, such as a plurality of pins, disposed within the tubing to displace the food product. An alternative means is a tapering of the tubing to reduce the cross-sectional area of the passage through the tubing. Another alternative means is a flow-restrictive orifice that causes back-pressure in the tubing.

### BRIEF DESCRIPTION OF THE SEVERAL VIEWS OF THE DRAWINGS

FIG. 1 is an exploded schematic view in perspective illustrating the preferred embodiment of the present invention.

FIG. 2 is an exploded schematic view in perspective illustrating an alternative embodiment of the present invention.

FIG. 3 is an exploded schematic view in perspective illustrating an alternative nozzle structure.

FIG. 4 is a view in perspective illustrating the present invention in a conventional pendulum slicer.

FIG. 5 is a view in perspective illustrating the present invention.

FIG. 6 is a view in perspective illustrating an apparatus for displacing the present invention during slicing.

FIG. 7 is a view in perspective illustrating an alternative nozzle structure.

FIG. 8 is a view in perspective illustrating an alternative nozzle structure, wherein the nozzle has an insert with pins 44 extending to the terminal end of the nozzle.

FIG. 9 is a view in perspective illustrating an alternative nozzle structure.

FIG. 10 is a view in perspective illustrating a portion of an alternative extrusion apparatus.

FIG. 11 is a view in perspective illustrating additional structures of the alternative extrusion apparatus of FIG. 10.

FIG. 12 is a view in perspective illustrating an alternative nozzle with an insert mounted thereto.

FIG. 13 is a view in perspective illustrating the flow divider and pump in relation to a slicing machine used in cooperation with the present invention.

FIG. 14 is a view in perspective illustrating an assembled nozzle and insert structure.

FIG. 15 is a view in perspective illustrating an expansion bell.

FIG. 16 is a view in perspective illustrating an alternative expansion bell.

FIG. 17 is a view in perspective illustrating an alternative expansion bell.

FIG. 18 is a view in perspective illustrating an alternative expansion bell.

FIG. 19 is a view in perspective illustrating an alternative expansion bell.

FIG. 20 is a view in perspective illustrating an insert ring.

FIG. 21 is a view in perspective illustrating an alternative insert ring.

FIG. 22 is a view in perspective illustrating an alternative insert ring.

FIG. 23 is a view in perspective illustrating an alternative insert ring.

FIG. 24 is a view in perspective illustrating an alternative insert ring.

FIG. 25 is a view in perspective illustrating an alternative insert ring.

FIG. 26 is a view in perspective illustrating an alternative insert ring.

FIG. 27 is a view in perspective illustrating a body insert.

FIG. 28 is a view in perspective illustrating an alternative body insert.

FIG. 29 is a view in perspective illustrating an alternative body insert.

FIG. 30 is a view in perspective illustrating an alternative body insert.

FIG. 31 is a view in perspective illustrating an alternative body insert.

FIG. 32 is a view in perspective illustrating an alternative body insert.

FIG. 33 is a view in perspective illustrating an alternative body insert.

FIG. 34 is a view in perspective illustrating an alternative body insert.

FIG. 35 is a view in perspective illustrating an alternative body insert.

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents that operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

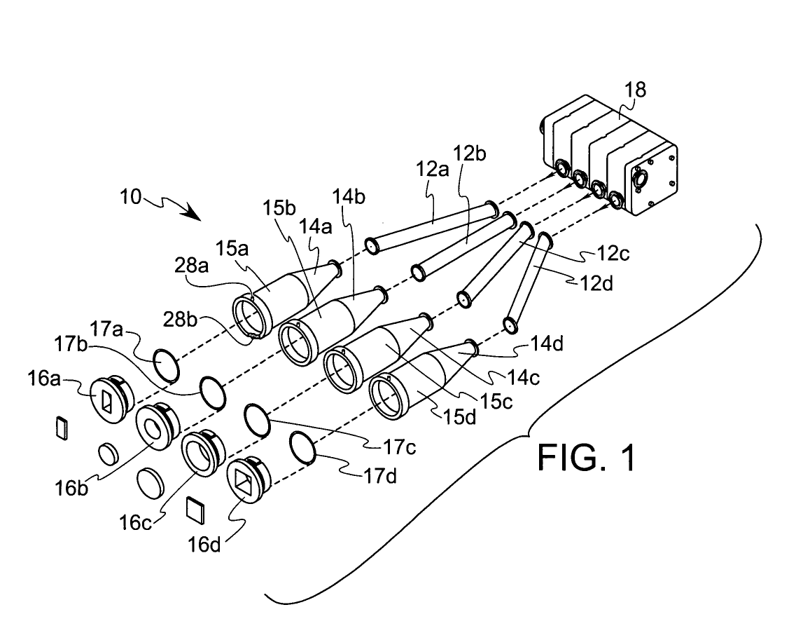

The invention shown in FIG. 1 is an extrusion assembly 10 that is preferably used in cooperation with a device that processes fluent material. The term “fluent material” is defined herein to include materials made of small pieces of solids, material made of semi-solids, pastes, slurries, gels, particulates and any other material that flows. For example, the extrusion assembly 10 can be used in cooperation with a conventional machine that grinds solid foods, such as meat, to form a raw sausage product that is fluent, and can be extruded by the invention.

After being extruded by the invention, the fluent food product is sliced into slices, and this can be accomplished by the pendulum slicing machines manufactured and sold by the J.E. Grote Company. In such a machine, a food product is reciprocated through a path that includes a slicing blade. Slices of the food product are formed during a portion of the reciprocation cycle and the slices are conveyed to a conveyor or another suitable substrate. During the remaining portion of the reciprocation cycle, the food product extends further so that upon its return to the blade portion of the path, another thickness is sliced. In the conventional machine, a solid food log, such as a salami, is sliced. However, the extrusion assembly 10 permits fluent food products to be sliced by this machine due to the structures that will now be described.

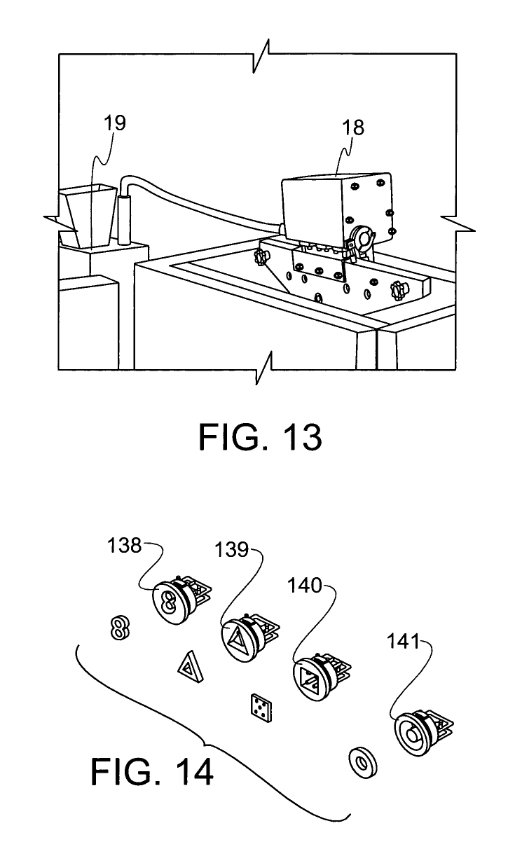

The extrusion assembly 10 is shown in FIG. 1 connected to a flow divider 18. The flow divider is connected to a pump 19 (see FIG. 13) for pumping the fluent food product through the flow divider 18, through the extrusion assembly 10, and out of orifices to be sliced. The pump 19 is a conventional pump, such as the Handtmann model number VF620, although it will become apparent that other food-grade pumps will suffice. The extrusion assembly 10 includes the delivery tubes 12a-12d, the expansion bells 15a-15d and the nozzles 16a-16d for extruding the fluent material that will be sliced to form finished products.

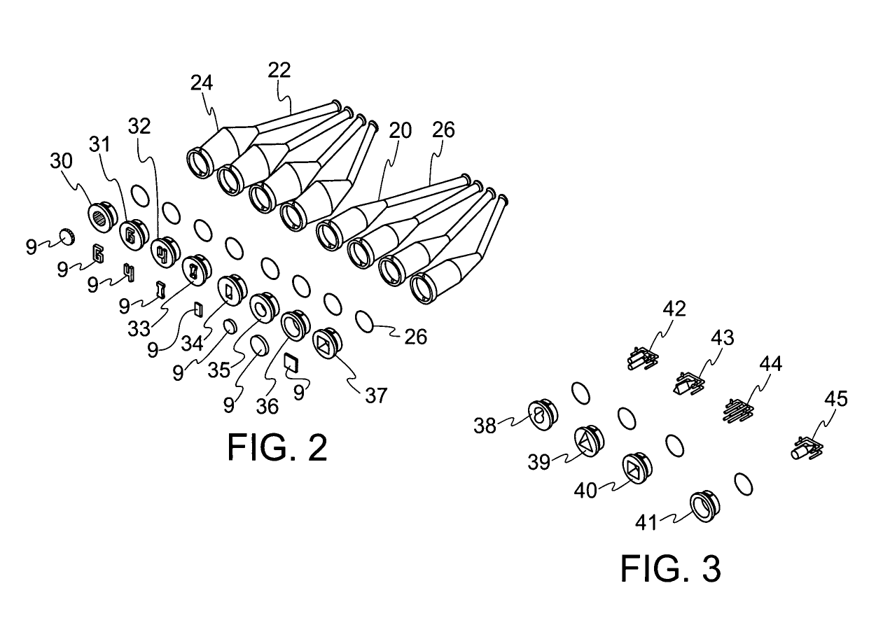

The delivery tubes 12a-12d have a circular cylindrical passageway that conveys fluent material (not shown) from the flow divider 18, such as the flow divider shown in U.S. patent application Ser. No. 10/625,419, which was filed on Jul. 23, 2003 and is incorporated herein by reference, to the expansion bells 14a-14d. The delivery tubes 12a-12d may be any length necessary to compensate for differences in lane spacing from the flow divider 18 to the finished product 9 (shown, as an example, in FIG. 2). The shape of the delivery tubes 12a-12d may be any cylindrical shape, such as square, oval, triangular or octagonal. The preferred shape is a circular cylinder.

The expansion bells 15a-15d are tubes having a preferably circular passage therethrough and a diameter the same size as the delivery tubes 12a-12d, and expanding to larger than the diameter of the delivery tubes 12a-12d. The conical sections 14a-14d extend between the delivery tubes 12a-12d (having a first diameter) and the non-conical sections of the expansion bells 15a-15d (having a second, larger diameter). The expansion bells 15a-15d can have any cylindrical shape including, but not limited to, circular, oval, rectangular, triangular or octagonal.

Thus, as fluent material flows from the flow divider 18, it passes through the tubes 12a-12d, expands in diameter in the conical sections 14a-14d, flows through the passages in the remainder of the expansion bells 15a-15d, and is extruded out of the nozzles 16a-16d. From the pump 19 to the orifices of the nozzles 16a-16d, fluent food product flows through tubing, albeit of different shapes and sizes and of changing sizes along the tubes' path. The term “tube”, therefore, is defined herein as an outer sidewall that defines an inner passage through which fluent material can be pumped and the sidewall having any shape or cross-sectional configuration.

In a preferred embodiment, there is a structure that restricts the flow of the fluent material through the passage between the pump and the exterior of the nozzles. The flow restriction causes the fluent material to be compressed, thereby removing any voids formed during the steps preceding the slicing step. This is accomplished in the invention by reducing the local cross-sectional area of the passage through which the fluent material passes. The reduction in cross-sectional area increases the pressure locally, thereby removing voids. This reduction can be effected by various structures.

In the preferred embodiment, the flow restriction is accomplished by flow-restrictive orifices formed in the nozzles 16a-16d. The orifices are of an area substantially smaller than the cross-sectional area of the expansion bells 15a-15d. The fluent material being pumped through the expansion bells 15a-15d is thereby compressed slightly before being extruded through the orifices formed in the nozzles 16a-16d. This compressing, caused by the flow restriction of the nozzles, removes most or all of the unwanted voids in the fluent material by the time the material is extruded out of the orifices. It is also possible to have non-flow-restrictive orifices in the nozzles, so long as another flow-restrictive means is used to remove voids.

In order for compression to occur at the orifices, the expansion bells 15a-15d have passages therein that are larger in cross-sectional area than the orifices formed in the nozzles 16a-16d. The nozzles 16a-16d thus function as flow restrictors creating backpressure in the larger passages of the expansion bells 15a-15d to increase the density of the fluent material before it is extruded. This pressure reduces unwanted voids in the food product and forces the fluent material to conform to the shape created by the nozzles 16a-16d.

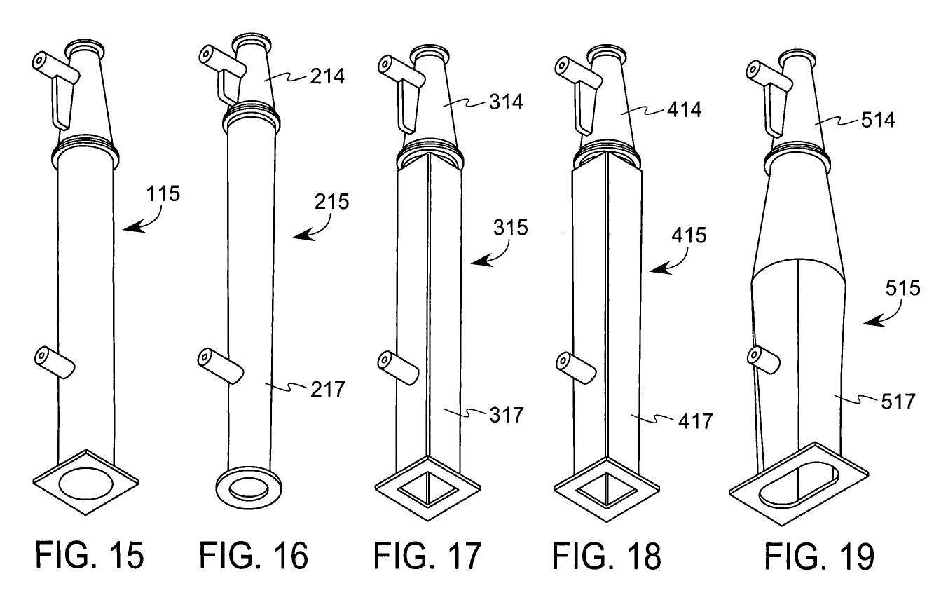

The expansion bells of the preferred embodiment have a conical section and a circular cylindrical tubular section. However, expansion bells can be made of any shape, and can be tapered from the pump end to the orifice end in order to restrict flow and, thereby, remove voids from the fluent material. This “tapering” is a reduction in the internal area of the expansion bell along the flow path of the fluent material. For example, FIG. 15 shows an expansion bell 115 that has the preferred conical section connected to a circular cylindrical section. FIG. 16 illustrates an alternative expansion bell 215 having a conical section 214 and a tapered section 217. In FIG. 17, another alternative expansion bell 315 has a conical section 314 and a rectangular cylindrical section 317. In FIG. 18, the expansion bell 415 has a conical section 414 and a tapered rectangular section 417. In FIG. 19, the expansion bell 515 has a conical section 514 and a section 517 that connects to the conical section 514 in a circular shape, but changes to an oval opening at the opposite end. Thus, the shapes of the sections of expansion bells can change from one shape to another in order to produce a particular shape, or to taper for flow restriction, or both.

In the preferred embodiment, the nozzles 16a-16d have circular cylindrical, radially outwardly facing surfaces to fit inside the discharge ends of the respective expansion bells 15a-15d. The nozzles' passages extend from each nozzle's connection end to its discharge end where it forms an orifice of a particular shape and size. The nozzles 16a-16d have o-rings 17a-17d on their radially outwardly facing surfaces that seat against the radially inwardly facing surfaces of the respective expansion bells 15a-15d to seal the gaps between the facing surfaces of the nozzles and the bells.

The preferred expansion bells 15a-15d have two alignment pins 28a and 28b, near the discharge ends of the expansion bells 15a-15d. These pins 28a and 28b extend into slots formed in the nozzles 16a-16d to secure the nozzles to the expansion bells as described in further detail below.

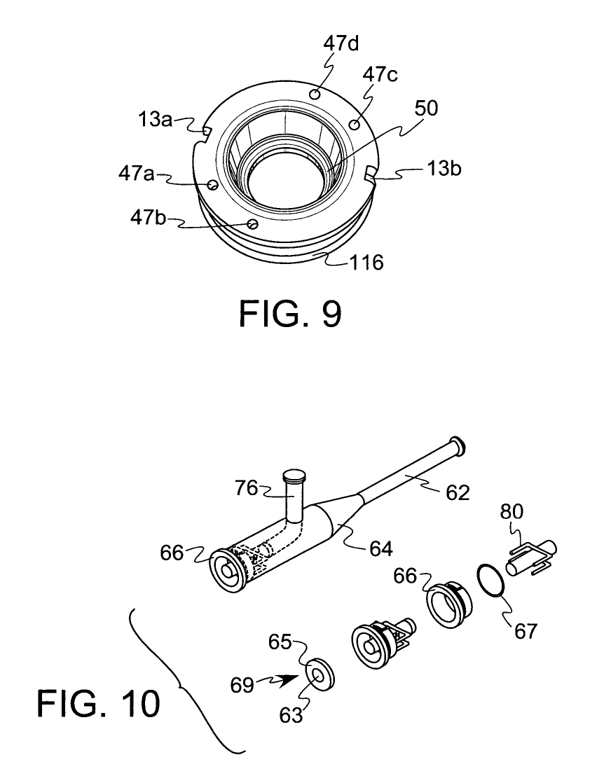

The preferred nozzles have two L-shaped slots on opposite sides thereof, as illustrated on the nozzle 16a, which is exemplary. As illustrated in FIG. 9, the slots 13a and 13b receive the alignment pins 28a and 28b of the expansion bell 15a. When the nozzle is rotated approximately thirty degrees after registration of the pins 28a and 28b in the slots 13a and 13b, the pins lock the nozzle 16a into place on the bell 15a. Of course, the nozzle 16a can be connected to the expansion bell 15a with other connecting means as will be recognized by the skilled artisan.

The nozzle 16a is interchangeable with other nozzles that fit in the expansion bell 15a, thereby making it easy for a user to switch from one nozzle, having a particular orifice shape or size, to a different nozzle. FIGS. 2 and 3 illustrate a few examples of the different types, sizes and shapes of nozzles that can be used with the preferred embodiment. For example, the circular nozzle 16 can be replaced by the nozzle 30 with a crimped orifice, the nozzle 31 with a letter-shaped orifice, the nozzle 32 with a number-shaped orifice, the nozzle 33 with a geometric-shaped orifice, the nozzle 34 with a rectangular orifice, the nozzle 35 with a small, round orifice, the nozzle 36 with a larger round orifice, or the nozzle 37 with a square orifice. These are only a few examples of the many different types of nozzle orifices that can be used with the invention. A person of ordinary skill in the art will recognize that other orifice shapes and sizes are possible.

The radially-inwardly facing surface of the orifice passage extending through a nozzle can be the same shape and size along the entire length of the orifice. Alternatively, the shape of the orifice sidewall can change abruptly or gradually near the discharge end of the nozzle. As illustrated in FIG. 9, the nozzle 116 has a radially-inwardly facing flange 50 at the discharge end of the orifice sidewall. Thus, the discharge end of the nozzle 116 has a smaller diameter than the opposite end and most of the length of the orifice passage in the nozzle 116.

The flange 50 affects the pressure and flow rate of the fluent material as it exits the nozzle 116. The pressure of the fluent material is increased at the flange 50 and the fluent product is extruded from the nozzle 116 in a manner that prevents thickness variations in the finished, sliced product. Without the flange 50, some fluent material would tend to form a dome shape upon discharge from the nozzle. With the flange 50, the doming is eliminated or dramatically reduced. The flange 50 thus facilitates product uniformity during and after extrusion.

In an alternative embodiment shown in FIG. 7, the nozzle 216 has an abrupt increase in diameter at the discharge end to form a chamfered edge 218 at the discharge end of the nozzle 216. This chamfered edge 218 can be sharp, such as by cutting a chamfer at a 45 degree angle with the axis of the nozzle 216, or it can be smooth, such as by rounding the lip of the nozzle. These are only a few examples of the types of discharge end structures that can be incorporated into the nozzles of the present invention, and a person of ordinary skill in the art will recognize that others exist.

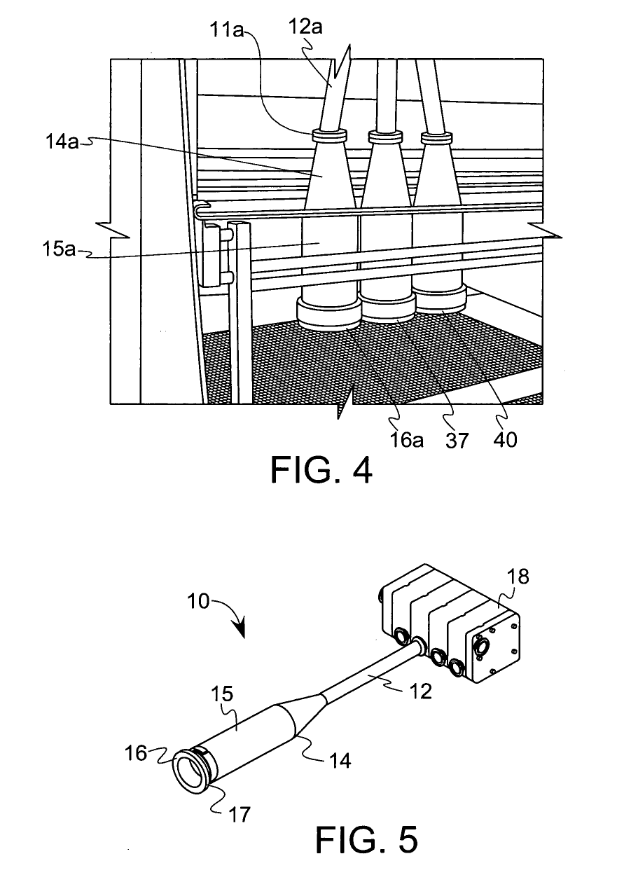

In the preferred embodiment, each of the tubes 12a-12d is mounted to a respective expansion bell 15a-15d in the same manner. As shown in FIG. 4, the coupling 11a is used to attach the delivery tube 12a to the expansion bell 15a in a manner that is removable for cleaning, yet seals the abutting flanges of each. In the preferred embodiment, the coupling 11a is a circular ring that fits around the abutting flanges formed on the ends of the delivery tube 12a and the expansion bell 15a. Of course, the coupling 11a can be any other suitable connection means as a person of ordinary skill in the art will recognize. For example, the coupling 11a can be replaced by a pin and slot arrangement as with the preferred bells 15a-15d and nozzles 16a-16d. Alternatively, the coupling 11a can be replaced by a weld that effectively integrates the bells and tubes into a unified structure.

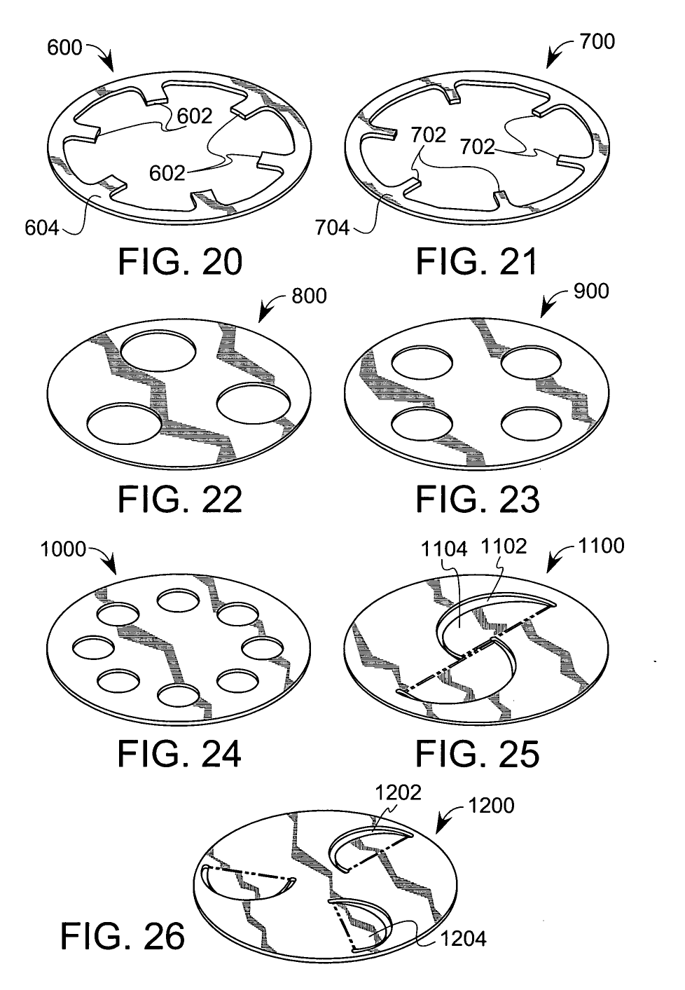

Another means by which the flow can be restricted in the flow passage of the fluent material, and which may also have other desirable effects on the fluent material such as altering the velocity of the fluent material, is bodies inserted into the flow passage, preferably in or close to the expansion bells 15-15d. These bodies displace fluent material to increase the pressure, thereby forcing out voids. The bodies can also direct the flow in a particular direction. For example, the restrictor ring 600 is illustrated in FIG. 20 having a plurality of fingers 602 extending radially inwardly from an annulus 604. When placed in the flow passage, such as between the flanges of the tube 12a and the expansion bell 15a, the fingers 602 will restrict the flow of fluent material therethrough, thereby increasing pressure and removing unwanted voids. The restrictor ring 700, shown in FIG. 21, has slightly smaller fingers 702 extending radially inwardly from an annulus 704. The determination of which of the rings 600 and 700 will be used in a particular situation will be based primarily upon the characteristics of the fluent material, but also upon other factors that will become apparent.

The ring inserts 800, 900 and 1000 shown in FIGS. 22, 23 and 24, respectively, can also be inserted into the flow passage of the extrusion assembly in order to restrict the flow of fluent material. Because they have apertures smaller than the opening in the inserts 600 and 700, the inserts 800-1000 will restrict flow to a greater extent than the inserts 600 and 700, as will be appreciated by the person of ordinary skill. However, the inserts 800-1000 will at times be desired, based primarily on the characteristics of the fluent material.

The inserts 1100 and 1200, shown in FIGS. 25 and 26, respectively, have apertures 1102 and 1202 therethrough, and also have flaps 1104 and 1204 that direct the fluent material in a particular direction. The flaps cause a “swirling” action during flow of the fluent material through the inserts 1100 and 1200. This may be desirable under particular circumstances.

The inserts 42, 43, 44 and 45 shown in FIG. 3 are bodies disposed in the flow passage of the nozzles rather than in the expansion bells. The nozzle inserts 42-45 have a variety of shapes and sizes of pins that can be positioned in the passages of the nozzles through which the fluent food product material flows. Some pins are circular cylinders, such as in the inserts 42, 44 and 45. The pin of the insert 43 is a triangular cylinder. The pins of the nozzle inserts 42-45 are a variety of shapes and sizes, and are examples of the types of bodies that can be inserted into the nozzle orifice to form openings in the finished products, as shown in FIG. 14, to simply reduce the unwanted voids in the extruded food product material, or both. If the pins of the inserts are installed far enough away from the orifice, the fluent material forms openings as it flows around the pins, but the openings close before the material is extruded and sliced. If the pins extend to the end of the orifice, as shown in FIGS. 8 and 14, the pins form openings in the finished products. It is preferred that the shapes of the pins correspond to the shape and size of the orifice of the nozzle, although this is not necessary.

The inserts can be attached to the nozzles in any suitable manner. For example, the back of the nozzle 116 (see FIG. 9) has alignment holes 47a, 47b, 47c and 47d formed therein. The insert support pins 46a, 46b, 46c and 46d, shown in FIG. 12, can be pushed into the alignment holes to secure the insert 45 to the nozzle 116, and align the pins of the insert with the passage of the nozzle. The nozzle 41 (see FIG. 3) has similar alignment holes, and the insert 45 can be installed therein to provide a circular cylindrical pin in the nozzle's aperture to form an opening in the product formed from fluent material that has been extruded and sliced. The round nozzle 41 and nozzle insert 45 create a donut-shaped product from raw dough extruded through the nozzle 41 orifice and then sliced. A donut-shaped product made using an insert and nozzle similar to that shown in FIG. 3 is shown in FIG. 14.

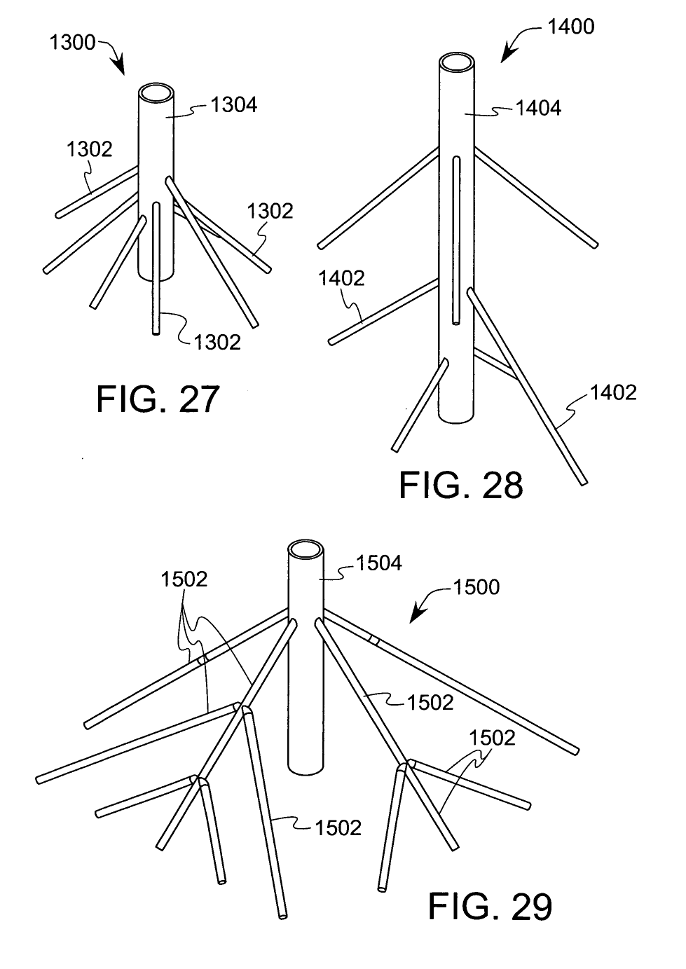

As shown in FIGS. 27, 28 and 29, the bodies 1300, 1400 and 1500 have pins 1302, 1402 and 1502, respectively. The pins 1302, 1402 and 1502 mount to cores 1304, 1404 and 1504, respectively, that can be mounted to the sidewall of the tubes 12a-12d, the expansion bells 15a-15d or any other structure that permits mounting. The pins displace the fluent material flowing through the passage in which the body is mounted, thereby reducing unwanted voids. Furthermore, the pins can affect the flow of the fluent material to cause fibers and large particular matter to align. The bodies 1300-1500, however, do not extend close enough to the end of an orifice to form openings in the finished product.

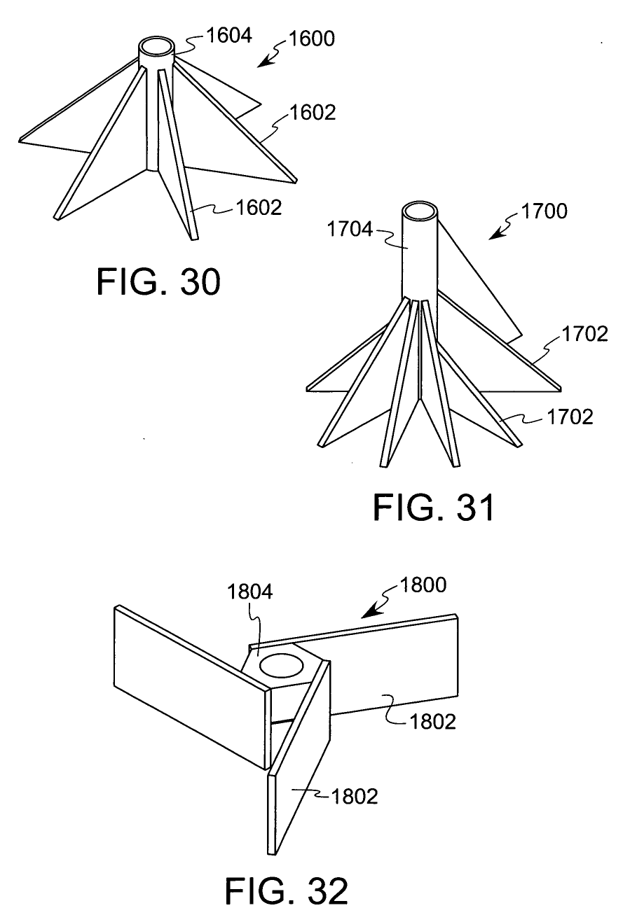

The bodies 1600, 1700, 1800 and 1900 shown in FIGS. 30, 31, 32 and 33, respectively, can also be inserted into the flow passage to affect the fluent material. The body 1600 has a central core 1604 with the similarly sized and mounted fins 1602 extending radially outwardly therefrom. The body 1700 has a central core 1704 to which different sized and shaped fins 1702 are mounted to have a different effect on the fluent material. The body 1800 has a central core 1804 and planar fins 1802 extending outwardly therefrom, whereas the body 1900 has a central core 1904 and non-planar fins 1902 extending outwardly therefrom to cause “swirling” of the fluent material.

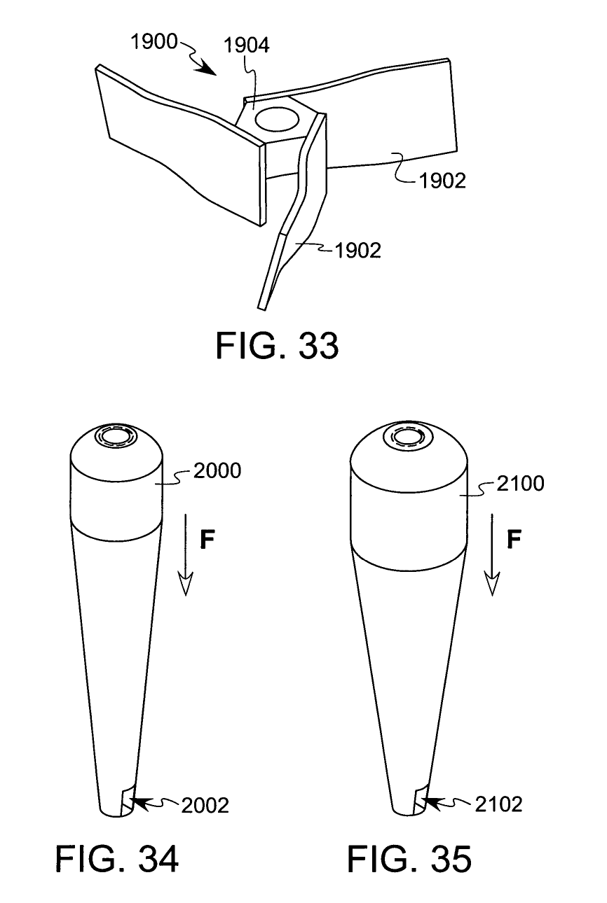

The bodies 2000 and 2100 shown in FIGS. 34 and 35, respectively, can be inserted into the flow passage by extending a rod from the sidewall of the tube through the slots 2002 and 2102, respectively. The flow of fluent material is preferably in the direction of the reference arrow, F, although this is not necessary. The bodies 2000 and 2100, which are slightly different in diameter, displace a substantial amount of fluent material, thereby causing the removal of unwanted voids in the fluent material. These are but a few examples of bodies that can displace and affect the fluent material flowing through the extrusion assembly of the present invention.

In operation, the flow divider 18 receives fluent material from the pump, which pumps the fluent material through the entire assembly. The fluent material can be raw sausage, dough, hamburger, or any other fluent food product, as described above. The pressure of the pump forces the fluent material through the delivery tubes 12a-12d, into the expansion bells 15a-15d where the velocity of the fluent material slows because the cross-sectional area of the expansion bells increases from that of the delivery tubes. The fluent material is pushed through the passages of the tubular expansion bells 15a-15d into the nozzles 16a-16d where the fluent material conforms to the shape of the orifices of the nozzles 16a-16d. The fluent material flows around any inserts in the nozzles and an extrusion is formed that, when sliced, forms the products illustrated in FIGS. 2 and 14. The slices are formed once the elongated extrusion reaches a predetermined thickness, and the slices drop onto a conveyer belt or any other slice-receiving structure.

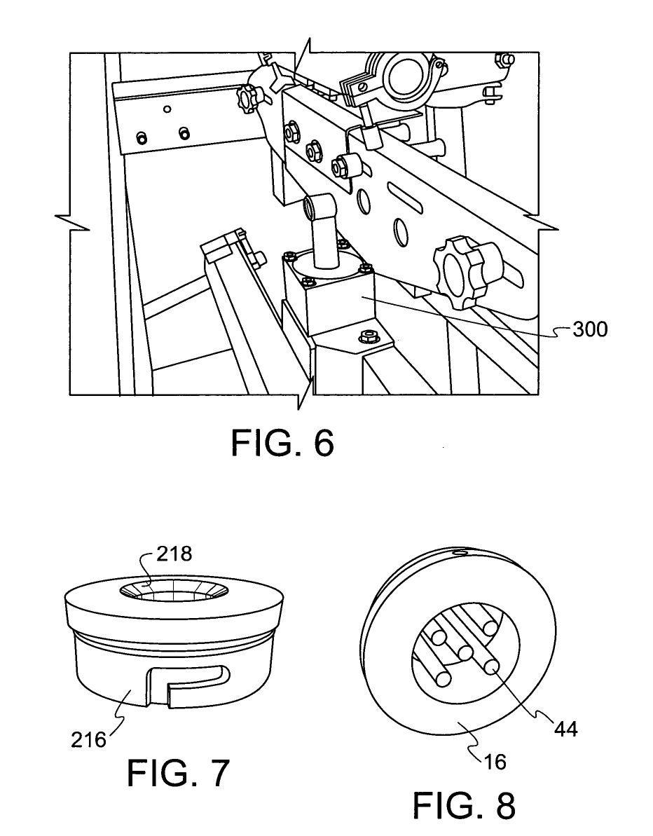

While the fluent material is flowing through the extrusion assembly 10, the extrusion assembly 10 is preferably moved rapidly away from and toward the cutting blade by a pneumatic ram 300 mounted to a frame member and the extrusion assembly (FIG. 6). The lower end of the extrusion assembly 10, at the nozzles, passes through a band-blade, such as is found in conventional pendulum slicing machines described herein. The toward and away from motion (i.e., “up and down” in the preferred embodiment) allows the fluent material to extend out of the nozzles when in the “up” position, and be sliced in cross section creating a finished product when in the “down” position. The amount of dwell time between slicing and the flow rate of the fluent material can be incorporated into data fed to a single computer controlling all devices in the system to control the slice thickness.

The extrusion device according to the present invention may have only one nozzle, or it may have a plurality of nozzles, each of which may be used simultaneously, and each having a different nozzle orifice to result in different finished products. Alternatively, each nozzle can have the same orifice shape and size.

The preferred nozzles are preferably ground so that their discharge ends have a curvature that matches the radius between the pivot point of the carriage and the slicing blade on the pendulum-slicing machine on which the nozzle is used. The nozzles are preferably made of a food-grade material, such as that sold under the trademark DELRIN, but may be made of any suitable material.

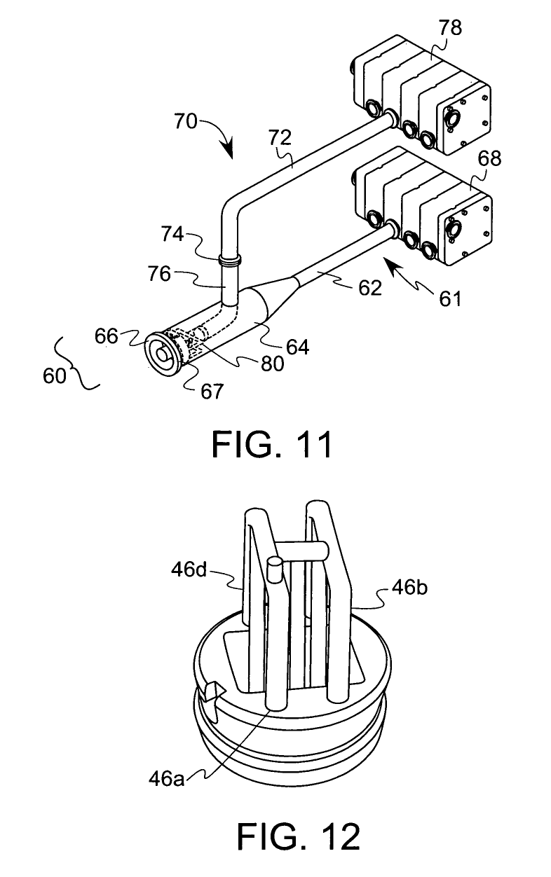

As illustrated in FIGS. 10 and 11, the co-extrusion assembly 60 has a first delivery tube 62 and a second delivery tube 72, each tube delivering different fluent food products to become the sliced product 69. Fluent food product material is moved from a primary flow divider 68 through a delivery tube 62, expansion bell 64 and nozzle 66 as described in the preferred embodiment above. However, in the FIGS. 10 and 11 embodiment, there is a secondary flow divider 78, which contains a secondary fluent material that is pushed through a second delivery tube 72, which is connected by a coupling 74 to a second expansion bell 76 that is fitted inside the primary expansion bell 64. A nozzle insert 80 is interposed inside the second expansion bell 76. The secondary fluent material is pushed through the secondary expansion bell 76 and nozzle insert to be combined with the primary fluent material near the nozzle to be sliced to form the final product 69. The primary fluent material is pushed through the primary expansion bell 64 and around the secondary expansion bell 76 to be combined to form the final product 69. The secondary assembly 70 is positioned above the primary assembly 61 in the preferred embodiment. However, the assemblies 61 and 70 may be connected in a variety of positions, including side-by-side, top or bottom.

The primary and secondary fluent materials are compressed into one finished product 69, as illustrated in FIG. 10. The secondary material makes up the inner ring 63 of the product 69 and the primary material makes up the outer ring 65 of the product 69. Of course, the nozzle 66 may be altered to have one of a variety of sizes or shapes, as can the secondary expansion bell 76. For example, the nozzle 66 and the secondary expansion bell 76 may be circular, square, triangle or octagonal in shape. This alternative embodiment enables a user to add two different types of material into one product 69, such as a cookie having two different colored or textured cores.

While certain preferred embodiments of the present invention have been disclosed in detail, it is to be understood that various modifications may be adopted without departing from the spirit of the invention or scope of the following claims.

1. A food processing machine for pumping and slicing fluent food product, the machine comprising:
(a) a pump for pumping the food product;
(b) a tube mounted to the pump and having an internal passage in fluid communication with the pump;
(c) an orifice near an end of the tube in fluid communication with the passage;
(d) a blade near the orifice for slicing food product extruded out of the orifice; and
(e) means for restricting flow of food product between the pump and the orifice for removing unwanted voids in the food product.

2. The machine in accordance with claim 1, wherein the tube further comprises an expansion bell between the pump and the orifice.

3. The machine in accordance with claim 2, wherein the orifice is formed in a nozzle removably mounted to the expansion bell.

4. The machine in accordance to claim 3, wherein the cross-sectional area of the orifice at the nozzle's terminal edge has an abrupt change for affecting the fluent material flowing therethrough.

5. A food processing machine for pumping and slicing fluent food product, the machine comprising:
(a) a pump for pumping the food product;
(b) a tube mounted to the pump and having an internal passage in fluid communication with the pump;
(c) an orifice near an end of the tube in fluid communication with the passage;
(d) a blade near the orifice for slicing food product extruded out of the orifice; and
(e) at least one body mounted in the passage of the tube for reducing the cross-sectional area of the passage at the body, thereby restricting flow of food product between the pump and the orifice for removing unwanted voids in the food product.

6. The food processing machine in accordance with claim 5, wherein the tube has a sidewall and said at least one body further comprises a plurality of spaced pins that are spaced from the sidewall.

7. The food processing machine in accordance with claim 6, wherein the pins extend to the orifice.

8. The food processing machine in accordance with claim 5, wherein the sidewall tapers from the pump to the orifice.

9. The food processing machine in accordance with claim 8, wherein the orifice is flow restrictive.

10. The machine in accordance with claim 5, wherein the tube further comprises an expansion bell between the pump and the orifice.

11. The machine in accordance with claim 10, wherein the orifice is formed in a nozzle removably mounted to the expansion bell.

12. A food processing machine for pumping and slicing fluent food product, the machine comprising:
(a) a pump for pumping the food product;
(b) a tube mounted to the pump and having an internal passage in fluid communication with the pump;
(c) an orifice near an end of the tube in fluid communication with the passage; and
(d) a blade near the orifice for slicing food product extruded out of the orifice;
wherein the tube has a sidewall that tapers from the pump to the orifice, thereby reducing the cross-sectional area of the flow passage and restricting flow of food product between the pump and the orifice for removing unwanted voids in the food product.

13. The food processing machine in accordance with claim 12, further comprising at least one body mounted in the passage of the tube for reducing the cross-sectional area of the passage at the body.

14. The food processing machine in accordance with claim 13, wherein said at least one body further comprises a plurality of spaced pins that are spaced from the sidewall.

15. The food processing machine in accordance with claim 14, wherein the pins extend to the orifice.

16. The food processing machine in accordance with claim 12, wherein the orifice is flow restrictive.

17. The machine in accordance with claim 12, wherein the tube further comprises an expansion bell between the pump and the orifice.

18. The machine in accordance with claim 17, wherein the orifice is formed in a nozzle removably mounted to the expansion bell.

19. A food processing machine for pumping and slicing fluent food product, the machine comprising:
(a) a pump for pumping the food product;
(b) a tube mounted to the pump and having an internal passage in fluid communication with the pump;
(c) a flow-restrictive orifice near an end of the tube and in fluid communication with the passage for restricting flow of food product between the pump and the orifice for removing unwanted voids in the food product; and
(d) a blade near the orifice for slicing food product extruded out of the orifice.

20. The food processing machine in accordance with claim 19, further comprising at least one body mounted in the passage of the tube for reducing the cross-sectional area of the passage at the body.

21. The food processing machine in accordance with claim 20, wherein the tube has a sidewall and said at least one body further comprises a plurality of spaced pins that are spaced from the sidewall.

22. The food processing machine in accordance with claim 21, wherein the pins extend to the orifice.

23. The food processing machine in accordance with claim 19, wherein the tube sidewall tapers from the pump to the orifice.

24. The machine in accordance with claim 19, wherein the tube further comprises an expansion bell between the pump and the orifice.

25. The machine in accordance with claim 24, wherein the orifice is formed in a nozzle removably mounted to the expansion bell.

26. A method of pumping and slicing fluent food product, the method comprising:
(a) pumping the food product through a tube mounted to a pump, the tube having an internal passage in fluid communication with the pump;
(b) restricting the flow of food product through the tube to remove unwanted voids in the food product;
(c) extruding the food product through an orifice near an end of the tube; and
(d) slicing extruded food product exiting the orifice.

27. The method in accordance with claim 26, wherein the step of restricting the flow of food product further comprises mounting at least one body in the passage of the tube for reducing the cross-sectional area of the passage at the body.

28. The method in accordance with claim 26, wherein the step of restricting the flow of food product further comprises mounting, in the passage of the tube, a plurality of spaced pins that are spaced from the sidewall for reducing the cross-sectional area of the passage at the pins.

29. The method in accordance with claim 26, wherein the step of restricting the flow of food product further comprises tapering the tube sidewall from the pump to the orifice.

30. The method in accordance with claim 26, wherein the step of restricting the flow of food product further comprises forming an orifice that is flow restrictive.
